(19) United States
(12) Patent Application Publication
(10) Pub. No.: US 2002/0184081 A1
(43) Pub. Date: Dec. 5, 2002

(54) Vehicle development method using on-line data

(76) Inventor: Myung-Bin Han, Yongin-city (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/020,896

(22) Filed: Dec. 19, 2001

(30) Foreign Application Priority Data
May 29, 2001 (KR) 10-2001-0029692

(51) Int. Cl. G06F 17/60

(52) U.S. Cl. 705/10

(57) ABSTRACT

A vehicle development method using on-line data is provided which includes: receiving inputted data on vehicle evaluation criterion items and data on vehicle evaluation items; organizing a database on the basis of the received data; and converting the organized database into a vehicle developer standard database that can be used by the vehicle developer.

### CROSS-REFERENCE TO RELATED APPLICATION

This application claims priority of Korea patent Application No. 10-2001-0029692, filed on May. 29, 2001.

### BACKGROUND OF THE INVENTION

(a) Field of the Invention

The present invention relates to a vehicle development method, and more particularly, to a method in which a development direction is determined using data provided on-line.

(b) Description of the Related Art As computer network technology has developed, especially world wide web (WWW) technology, the population of computer network users and Internet users has rapidly increased. The Internet, a global network connecting millions of computers, has become a part of life for many people. Internet users acquire much information and perform many economic activities using computers connected to the Internet.

Computers connected to the Internet exchange much information using variable services, i.e., e-mail or a Gopher system, etc., and a server computer, such as a web server sends many web pages containing various data and information to be displayed on monitors of distant client computers, via the world wide web.

Generally, a vehicle developer gets data for vehicle development through an experiment device or a paper questionnaire, but these methods require a high cost and a long period of time. Also, it is quite difficult to acquire data from people from various levels of society, so it is difficult to acquire credible data for vehicle development.

### SUMMARY OF THE INVENTION

The present invention has been made in an effort to solve the above problem. It is an object of the present invention to provide a vehicle development method using on-line data in which credible data for vehicle development can be acquired from various vehicle users at a low cost.

The vehicle development method using on-line data according to the present invention comprises:

(a) receiving data on vehicle evaluation criterion items and data on vehicle evaluation items;

(b) organizing a database on the basis of the received data; and

(c) converting the organized database into a vehicle developer standard database that can be used by the vehicle developer.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic block diagram showing a system to which a vehicle development method using on-line data according to the present invention is applied; and

FIG. 2 is a flowchart showing the vehicle development method according to the present invention.

### DETAILED DESCRIPTION OF THE PREFERRED EMBODIMENTS

Hereinafter, a preferred embodiment of the present invention will be described in detail with reference to the accompanying drawings.

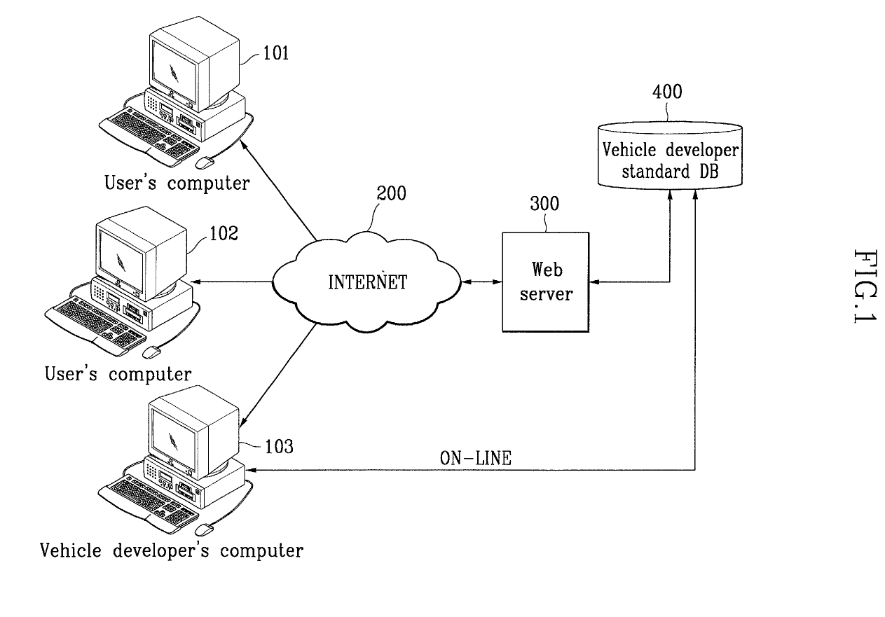

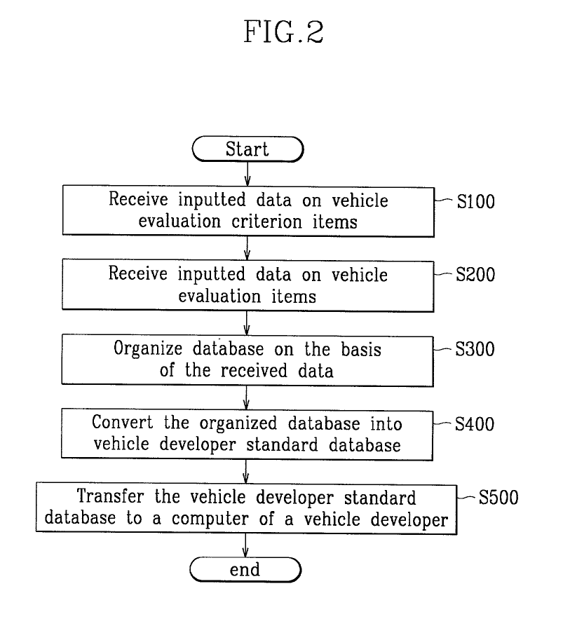

FIG. 1 is a schematic block diagram showing a system to which a vehicle development method using on-line data according to the present invention is applied, and FIG. 2 is a flowchart of the method according to the present invention.

Referring to the drawings, in the vehicle development method according to the preferred embodiment of the present invention, first, a web server 300 for vehicle development receives inputted data on vehicle evaluation criterion items and data on vehicle evaluation items (S1100 and S200). Various vehicle users input the data using their computers 101 and 102 that are provided with a web browser and are connected to the web server 300 through the Internet 200. The web browser is a software application used to locate and display web pages.

In step S100, the data on vehicle evaluation criterion items comprises personal information data of the data provider such as sex, age, occupation and weight, data on the vehicle such as vehicle model, manufacture year, elapsed mileage and maintenance history, and data on use history of the vehicle such as vehicle use category and an average driving amount.

In step S200, the data on vehicle evaluation items are of satisfaction degree through which a vehicle development direction can be determined, i.e., vehicle drivability, comfort, ease of entry and exit, visibility, noise and maintenance.

The data provider inputs the data on the web pages provided by the web server 300. The web server 300 is programmed in such a way that the data provider can input new data after the data provider inputs the data, and data on another vehicle model can also be inputted.

The web server 300 organizes a database (DB) by evaluation items on the basis of the received data (S300), then, by analyzing the database by evaluation items and applying an evaluation function for the vehicle development to the organized database, the web server 300 converts the organized database into a vehicle developer standard database 400 that can be used by the vehicle developer (S400).

That is, the web server 300 analyzes the organized database by the evaluation items such as sex, age, occupation, weight, province, manufacture year, use category and satisfaction degree, and then applies the evaluation function for the vehicle development.

If the converted database is demanded by the vehicle developer computer 103 that is connected to the web server 300 via the Internet or the internal network, the web server 300 transfers the converted database to the developer computer 103 (S500).

Using the converted database for developing a vehicle, the vehicle developer can develop the vehicle in accordance with the user's demands.

As stated above, the vehicle development method according to the present invention can acquire various data from various users such that accuracy and credibility of the data become higher.

Moreover, because the data is acquired through the Internet, the cost for acquiring the data is low, and because the database is established using the acquired data, the database can easily be applied to vehicle development. Also, a number of developers can simultaneously use the database through the Internet.

Although preferred embodiment of the present invention have been described in detail hereinabove, it should be clearly understood that many variations and/or modifications of the basic inventive concepts herein taught which may appear to those skilled in the present art will still fall within the sprit and scope of the present invention, as defined in the appended claims.

What is claimed is:

1. A vehicle development method using on-line data comprising:
(a) receiving data on vehicle evaluation criterion items and data on vehicle evaluation items;
(b) organizing a database on the basis of the received data; and
(c) converting the organized database into a vehicle developer standard database that can be used by a vehicle developer.

2. The method of claim 1 wherein in step (c), the organized database is converted into the vehicle developer standard database by an evaluation function for vehicle development.

3. The method of claim 1 wherein in step (a), the data on vehicle evaluation criterion items comprises data on personal information of a data provider, data on a vehicle and data on use history of the vehicle.

4. The method of claim 3 wherein:
the data on the personal information of the data provider comprises sex, age, occupation and weight;
the data on the vehicle comprises vehicle model, manufacture year, elapsed mileage, and maintenance history; and
the data on use history of the vehicle comprises vehicle use category and average driving amount.

5. The method of claim 1 wherein in step (a), the data on vehicle evaluation items comprises data on vehicle drivability, comfort, ease of entrance and exit, visibility, noise, and maintenance.

6. The method of claim 1 wherein the method further comprises
(d) transferring the converted database to a computer of the vehicle developer.
